(19) United States
(12) Patent Application Publication
(10) Pub. No.: US 2015/0146847 A1
(43) Pub. Date: May 28, 2015

(54) SYSTEMS AND METHODS FOR PROVIDING AN X-RAY IMAGING SYSTEM WITH NEARLY CONTINUOUS ZOOMING CAPABILITY

(71) Applicant: General Electric Company, Schenectady, NY (US)

(72) Inventor: James Zhengshe Liu, Salt Lake City, UT (US)

(73) Assignee: General Electric Company, Schenectady, NY (US)

(21) Appl. No.: 14/090,532

(22) Filed: Nov. 26, 2013

(51) Int. Cl. G01N 23/04; G21K 1/02; G01T 1/24

(52) U.S. Cl. CPC G01N 23/043; G01T 1/24; G21K 1/025
USPC 378/42

(57) ABSTRACT

Systems and methods for obtaining and displaying an X-ray image are described. The X-ray system contains an X-ray source, a CMOS based X-ray detector containing an active area for detecting an X-ray beam from the X-ray source, the active area containing an array of physical detector pixels having a pixel size or dimension ranging from about 10 μm×10 μm to about 50 μm×50 μm, a collimator defining an aperture, wherein the collimator is configured for a user to center the aperture over any portion of the active area of the CMOS based X-ray detector, and a display device configured to receive and display an X-ray image containing an array of virtual image pixels that have been previously binned at the CMOS based X-ray detector. Other embodiments are described.

### FIELD

This application relates generally to systems and methods for obtaining and displaying an X-ray image. In particular, this application relates to systems and methods for providing an X-ray imaging system with nearly continuous zooming functionality utilizing a complementary metal-oxide semiconductor (CMOS) X-ray detector.

### BACKGROUND

A typical X-ray imaging system comprises an X-ray source and an X-ray detector. The X-rays that are emitted from the X-ray source can impinge on the X-ray detector and provide an X-ray image of an object (or objects) that are placed between the X-ray source and the X-ray detector. In one type of X-ray imaging system, a fluoroscopic imaging system, the X-ray detector is often an image intensifier or, more recently, a flat panel digital detector. X-ray detectors have been amorphous silicon (a-Si) based detectors having a random crystal lattice. The image from the X-ray detector is often then displayed on a display unit.

In some systems, a collimator can be placed between the X-ray source and the X-ray detector to limit the size and shape of the field of the X-ray beam. The collimator can shape or limit the X-ray beam to an area of a patient's body, or a particular region of interest, that requires imaging, preventing unnecessary X-ray exposure to areas surrounding the body part that is being imaged and protecting the patient from needless X-ray exposure.

### SUMMARY

This application relates to systems and methods for obtaining and displaying an X-ray image. The X-ray system contains an X-ray source, a CMOS based X-ray detector having an active area of an array of physical detector pixels for detecting X-rays from the X-ray source and capable of adjusting a virtual image pixel size by binning multiple physical detector pixels together according to a desired region of interest, wherein the array of physical detector pixels is comprised of pixels having a pixel size or dimension (e.g., height and width of a pixel) ranging from about 10 μm×10 μm to about 50 μm×50 μm, a collimator defining an aperture, wherein the collimator is configured to center the aperture over any portion of the active area of the CMOS based X-ray detector, and a display device configured to receive and display an X-ray image comprised of an array of virtual image pixels that have been previously binned at the CMOS based X-ray detector according to the desirable field of view or region of interest. The small pixel size enables the X-ray detector to have a large number of very small physical detector pixels that can be binned at the detector so that fewer pixels must be transmitted to the display while still transmitting an X-ray image with sufficient detail and clarity to be useful. Dynamic binning processes can be performed to enable a clinician to zoom in on, or magnify, a chosen region of interest of a patient's anatomy in real, or near real, time in order to obtain an enlarged view of the region of interest without sacrificing spatial image resolution. The X-ray system is used to generate, acquire, and display X-ray images of an object is placed between the X-ray source and the CMOS based X-ray detector, wherein the X-ray image visualizes an array of virtual image pixels that have been previously binned at the CMOS based X-ray detector.

### BRIEF DESCRIPTION OF THE DRAWINGS

The following description can be better understood in light of the Figures, in which:

FIG. 1 shows an embodiment of an X-ray image;

FIG. 2A shows a perspective view of some embodiments of an X-ray imaging system;

FIG. 2B shows a block diagram of some embodiments of an X-ray imaging system;

FIG. 3A shows a top down view of an embodiment of two X-ray collimator leafs;

FIG. 3B shows a top down view of an embodiment of two X-ray collimator leafs which overlap with those depicted in FIG. 3A;

FIG. 4 shows a top down view of an alternate set of overlapping collimator leafs according to another embodiment;

FIG. 5 shows an embodiment of a method for displaying an X-ray image;

FIG. 6A shows alternative fields of view available through binning an X-ray image according to some embodiments;

FIG. 6B illustrates a table listing alternative fields of view available through binning an X-ray image according to some embodiments;

FIG. 6C illustrates alternative fields of view relative to one another available through binning an X-ray image according to some embodiments;

FIG. 7A shows an embodiment of a method for operating an X-ray system through a touch-screen user interface;

FIG. 7B shows an alternative embodiment of a method for operating an X-ray system through a voice-operated user interface; and

FIGS. 8-9 show a computing environment that can be used in some embodiments of the described systems and methods.

The Figures illustrate specific aspects of the systems and methods for displaying X-ray images. Together with the following description, the Figures demonstrate and explain the principles of the methods and structures produced through these methods. In the drawings, the thickness of layers and regions are exaggerated for clarity. The same reference numerals in different drawings represent the same element, and thus their descriptions will not be repeated. As the terms on, attached to, or coupled to are used herein, one object (e.g., a material, a layer, a substrate, etc.) can be on, attached to, or coupled to another object regardless of whether the one object is directly on, attached, or coupled to the other object or there are one or more intervening objects between the one object and the other object. Also, directions (e.g., above, below, top, bottom, side, up, down, under, over, upper, lower, horizontal, vertical, “x,” “y,” “z,” etc.), if provided, are relative and provided solely by way of example and for ease of illustration and discussion and not by way of limitation. In addition, where reference is made to a list of elements (e.g., elements a, b, c, etc.), such reference is intended to include any one of the listed elements by itself, any combination of less than all of the listed elements, and/or a combination of all of the listed elements.

### DETAILED DESCRIPTION

The following description supplies specific details in order to provide a thorough understanding. Nevertheless, the skilled artisan would understand that the described systems and methods for obtaining and displaying X-ray images can be implemented and used without employing these specific details. Indeed, the described systems and methods can be placed into practice by modifying the illustrated devices and methods and can be used in conjunction with any other apparatus and techniques conventionally used in the industry. For example, while the description below focuses on systems and methods for displaying X-ray images that were created using a fluoroscopic X-ray device that obtains X-ray images in near real time, the described systems and methods (or portions thereof) can be used with any other suitable device or technique. For instance, the described systems and methods (or portions thereof) may be used in connection with single X-ray image acquisition systems, such as radiography, fluoroscopy, and mammography systems.

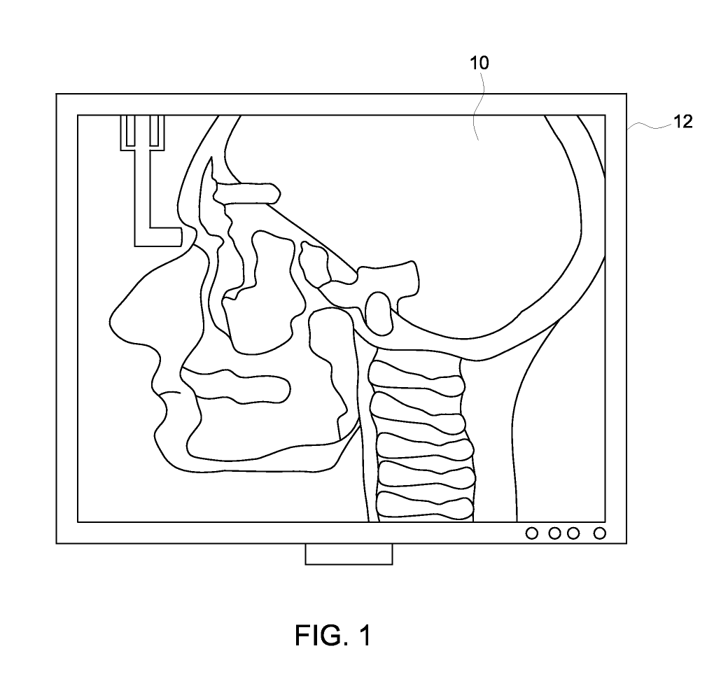

As mentioned above, this application generally relates to systems and methods for obtaining and displaying X-ray images. Some embodiments of an X-ray image 10 are shown in FIG. 1. In these embodiments, the X-ray image 10 can be shown on any display device 12. Examples of some display devices 12 include a square or rectangular cathode ray tube (CRT), light emitting diode (LED), organic light emitting diode (OLED), liquid crystal display (LCD), or thin film transistor (TFT) LCD monitor, a screen, a projector, a TV, a tablet or handheld device, or any other suitable viewing or display device. In some configurations, the X-ray image 10 can take up any amount of the display device's display area, including the entire display area so as to maximize both the size and resolution of the region of interest, or a sub-region of interest, to be viewed. As described in detail below, an operator (a clinician or radiologist, for example) can selectively zoom in on a chosen region of interest such that the zoomed region of interest or corresponding X-ray image is enlarged or magnified so as to fill the entire display area with a closer or magnified view of the selected region of interest while generally increasing the spatial image resolution.

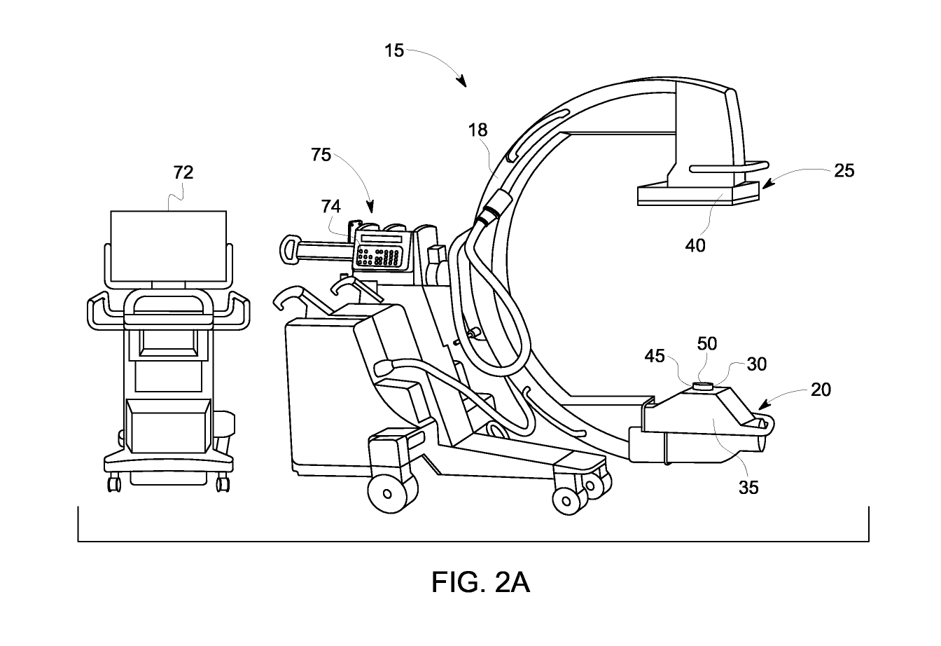

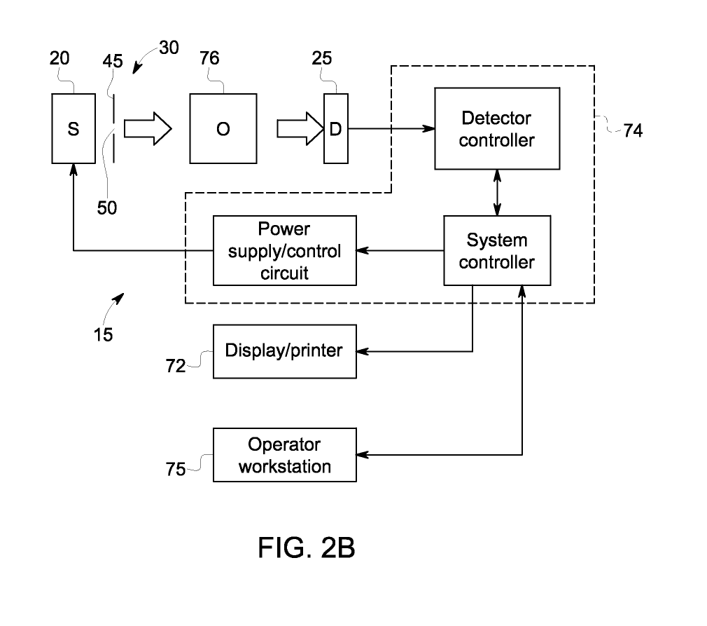

The X-ray images 10 can be produced by any X-ray system. In some embodiments, the X-ray image 10 can be produced by the X-ray system 15 illustrated in FIGS. 2A and/or 2B. The X-ray system 15 can comprise any suitable X-ray device that is capable of capturing and displaying the desired X-ray images 10. For example, the X-ray system can comprise a mobile X-ray device (e.g., an X-ray device comprising a C-arm, a mini C-arm, an O-arm, a non-circular arm, etc.), or a fixed X-ray device. By way of illustration, FIGS. 2A and 2B show an X-ray system 15. As shown in FIG. 2A, some embodiments of system 15 contain a C-arm X-ray device 18.

The X-ray system 15 can also comprise any component that allows it to take and display the X-ray images 10. In some configurations, FIGS. 2A and/or 2B show the X-ray system 15 comprises an X-ray source 20 within housing 35 device, an X-ray detector 25, a collimator 30, and a control/display unit, or operator work station, 75 containing or interfacing with a controller 74 and a monitor 72 (which may be the same or different than the display device 12). In some embodiments, monitor 72 is also associated with a printing device. Any X-ray source can be used, including a standard X-ray source, a rotating anode X-ray source, a stationary or fixed anode X-ray source, a solid state X-ray emission source, or any other X-ray source. Any X-ray detector 25 can be used, such as a flat panel digital detector 40 as shown in FIG. 2A. In some configurations, the X-ray detector comprises a square or a rectangular flat panel detector.

FIGS. 2A and/or 2B show some configurations in which collimator 30 comprises an X-ray attenuating material 45 that defines an aperture 50. The collimator 30 can comprise any suitable X-ray attenuating material 45 that allows it to collimate an X-ray beam. Some examples of suitable X-ray attenuating materials include tungsten, lead, gold, copper, tungsten-impregnated substrates (e.g., glass or a polymer impregnated with tungsten), coated substrates (e.g., glass or a polymer coated with tungsten, lead, gold, etc.), steel, aluminum, bronze, brass, rare earth metals, or combinations thereof. In some embodiments, the collimator comprises tungsten. The collimator 30 collimates an X-ray beam (not shown) so that a resultant X-ray image 10 comprises any suitable shape, such as rectangular, square, circular, ellipsoidal, oval, triangular, super-ellipsoidal, and so forth. In various embodiments, however, the collimator provides the image with a shape corresponding to a shape of aperture 50.

As shown in FIG. 2A, in some embodiments, the X-ray detector 25 comprises a square or a rectangular flat panel detector 40 having any suitable dimensions, including a length, a width, a radius, a circumference, a diameter, or the like, which dimensions define the active or receptive area of the detector. In various embodiments, flat panel detector 40 comprises a CMOS (complementary metal-oxide semiconductor) or crystalline silicon (c-Si) based detector having a well-ordered crystal lattice, as opposed to a traditional amorphous silicon (a-Si) based detector having a random crystal lattice. In various c-Si based detectors, monocrystalline silicon (Si) and/or polycrystalline silicon (poly-Si) structures are contemplated. Other crystalline materials besides silicon may also be used in accordance with the systems and methods disclosed herein.

The flat panel detector 40 comprising a CMOS based detector can be designed and constructed with an array of physical photodiode pixels (or detector pixels) distributed across the active or receptive area of the detector. The photodiode pixels are comparatively very small in size relative to pixel sizes achievable in traditional a-Si based detectors. For example, while the height and width of an individual pixel, or pixel size or dimension, in a traditional amorphous silicon based detector is generally much greater than the pixel size or dimension in a CMOS based detector, CMOS based detectors are capable of accommodating pixels having a height and width, or pixel size or dimension, that is/are much smaller than in an amorphous silicon based detector. Thus, the CMOS based detector pixels can be configured with a size or dimension ranging from, for example, about 10 μm×10 μm to about 50 μm×50 μm for a square pixel. In various embodiments, other pixel shapes are contemplated, such as rectangular pixels, and such pixels can be configured with any combination or sub-combination of sizes and dimensions within the range identified above.

Using a CMOS based X-ray detector allows the X-ray system 15 to facilitate nearly continuous zooming. This functionality is achieved by designing the CMOS based X-ray detector with suitably small pixels and then utilizing variable and/or dynamic binning processes in order to generate, capture, and display X-ray images having a desirable field of view at variable magnifications and resolutions so as to improve image quality. In this manner, a radiologist or clinician can elect to obtain and view an image of a specific region of interest of a patient's anatomy and zoom in on, or magnify, that region of interest with higher spatial image resolution.

In some configurations, the X-ray systems 15 use a collimator between the X-ray source and the X-ray detector to limit the size, shape, and/or field of the X-ray beam. The collimator can shape or limit the X-ray beam to an area of a patient's body, or a particular region of interest, that requires imaging, preventing unnecessary X-ray exposure to areas surrounding the body part that is being imaged and protecting the patient from needless X-ray exposure. Such a collimator can also help improve image contrast and quality by, for example, reducing or limiting excess X-rays from impinging on a flat panel digital detector, for example, thereby reducing or preventing image blooming or bleeding (which tend to occur when the detector is overloaded with X-rays). Thus, use of a collimator can minimize X-ray exposure and maximize the efficiency of the X-ray dosage to obtain an optimum amount of data for diagnosis.

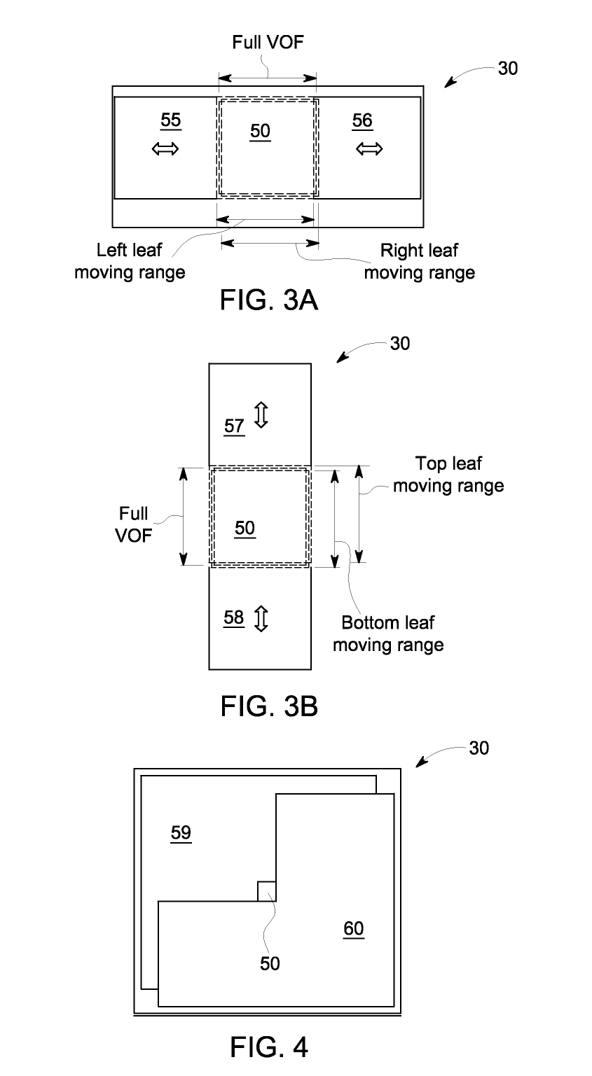

FIGS. 3A and 3B depict some embodiments of a collimator. As illustrated, collimator 30 comprises four plates or leafs 55, 56, 57 and 58. In various embodiments, it is contemplated that more than four plates or leafs can be used to comprise a suitable collimator while in other embodiments, as discussed below, fewer plates or leafs are contemplated. In some embodiments, leafs 55, 56, 57 and 58 are generally square. In other embodiments, leafs 55, 56, 57 and 58 are generally rectangular. In the illustration depicted as oriented at FIG. 3A, leaf 55 is generally a left moving leaf in that it moves horizontally from left to right on the left side of aperture 50. Conversely, leaf 56 is generally a right moving leaf as it moves horizontally from left to right on the right side of aperture 50. Similarly, in the illustration depicted as oriented at FIG. 3B, leaf 57 is generally an upper or forward moving leaf in that it moves horizontally forward and aft on the forward or top side of aperture 50 in the orientation depicted. Conversely, leaf 58 is generally a lower or rearward moving leaf in that it moves horizontally forward and aft on the reward or bottom side of aperture 50 in the orientation depicted. In some embodiments, collimator leafs 55, 56, 57 and 58 are made of high radiation absorbing material(s), such as tungsten or lead. In other embodiments, collimator leafs 55, 56, 57 and 58 are made of, or coated with, any of the attenuating materials 45 discussed above.

Collimator leafs 55 and 56 overlap with collimator leafs 57 and 58 such that the interaction of collimator leafs 55, 56, 57 and 58 defines an aperture 50. In some embodiments, the collimator leafs 55, 56, 57 and 58 are independently movable in the ranges and directions illustrated such that aperture 50 may be suitably sized and selectively and variably adjusted such that the X-ray beam is capable of being focused solely on an area of a patient's body, or a particular region of interest, that requires imaging, preventing unnecessary X-ray exposure to areas surrounding the body part that is being imaged and protecting the patient from needless X-ray exposure. According to such embodiments, the independent motion of collimator leafs 55, 56, 57 and 58 renders collimator 30 capable of selectively and variably moving aperture 50 defined thereby to any desirable region of interest within the collimator's range of motion such that a desirable field of view may be selected while minimizing the necessity of repositioning the patient or unnecessarily exposing the patient to needless X-ray exposure. In other words, in some embodiments, collimator leafs 55, 56, 57 and 58 interact such that the X-ray window or aperture 50 defined thereby is movable across the entire active area of a corresponding X-ray detector 25 such that aperture 50 may be centered over any discrete point or location of the detector's active or receptive area.

In some embodiments, collimator leafs 55, 56, 57 and 58 are motorized and positioned and re-positioned by various automated processes. In such embodiments, the operator may control the automated motion of collimator leafs 55, 56, 57 and 58 independently in order to position the leafs as desired. In other embodiments, collimator leafs 55, 56, 57 and 58 are manually adjustable and the clinician or radiologist may independently position and reposition them as desired. As discussed above, the independent positioning and repositioning of collimator leafs 55, 56, 57 and 58 is dictated by the desirable region of interest at any discrete point or location of the X-ray detector's active area that the clinician or radiologist desires to target or select.

FIG. 4 depicts alternative embodiments of collimator 30. As illustrated, collimator 30 comprises two generally overlapping, “L” shaped plates or leafs 59 and 60. In the illustration depicted as oriented at FIG. 4, leaf 59 is generally a left and forward moving leaf in that it moves horizontally from left to right and forward and aft on the left and top sides of aperture 50. Conversely, leaf 60 is generally a right and reward moving leaf as it moves horizontally from left to right and forward and aft on the right and bottom sides of aperture 50. As above, according to various embodiments, collimator leafs 59 and 60 are made of, or coated with, high radiation absorbing material(s), such as tungsten or lead, or any of the attenuating materials 45 discussed above.

In some embodiments, collimator leafs 59 and 60 are independently movable such that aperture 50 may be suitably sized and selectively and variably adjusted such that the X-ray beam is capable of being focused on an area of a patient's body, or a particular region of interest. Such independent motion also enables collimator 30 to be selectively and variably adjusted so as to position and reposition aperture 50 at any desirable region of interest within the collimator's range of motion as desired. In this way, in some embodiments, collimator leafs 59 and 60 interact such that the X-ray window or aperture 50 defined thereby is movable across the entire active area of a corresponding X-ray detector 25. In such embodiments, the x and y coordinates of collimator leafs 59 and 60 may be controlled so as to locate the center of aperture 50 over the relevant region of interest and to size aperture 50 such that the X-ray beam targets the entire region of interest without unnecessarily exposing the patient to needless X-rays. In some embodiments, collimator leafs 59 and 60 are motorized and automated. In other embodiments, collimator leafs 59 and 60 are manually positionable and adjustable.

The collimator 30 allows up to 100% of the associated X-ray detector's active or receptor area to be exposed to X-rays from the X-ray source. In various embodiments, however, collimator 30 allows less than 100% of the detector's receptor area to be exposed to X-rays from the X-ray source. Indeed, according to some embodiments, aperture 50 can allow any suitable combination or sub-range from 0% to 100% of the detector's receptor area to be exposed to X-rays from the X-ray source.

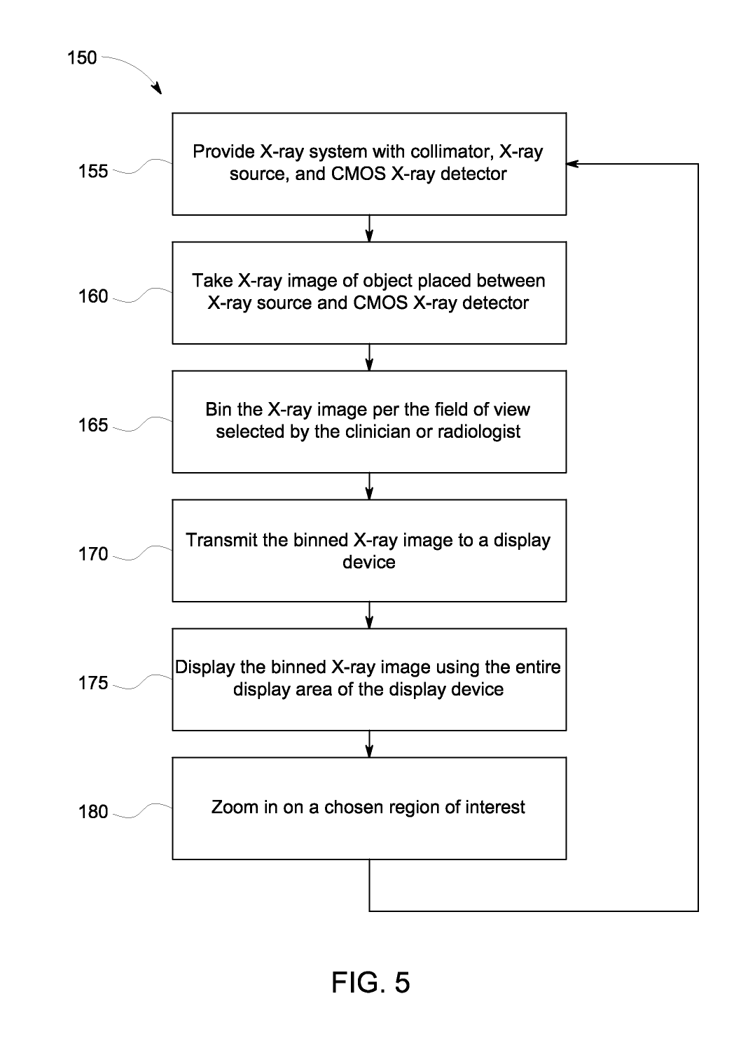

FIG. 5 shows some embodiments of a method 150 for acquiring and displaying the described X-ray images. This method can be modified in any manner, including by rearranging, adding to, removing, modifying, substituting, and otherwise modifying various portions of the method. As shown in FIG. 5, the method begins at 155 by providing an X-ray system, such as the x-ray system 15 illustrated in FIGS. 2A and/or 2B.

The method continues at 160 as X-ray image 10 is generated, taken and/or captured by placing an object between X-ray source 20 and X-ray detector 25 and passing a suitable X-ray beam through the object. In these embodiments, the X-ray detector 25 contains a photodiode array that detects the X-ray beam passing through the object and detected at the X-ray detector. The photodiodes of the array are sensitive to—and therefore detect—light. A scintillator can be used to convert the detected X-rays to light which then impinge on the photodiodes. The photodiodes then display the light image they receive on the pixels of the display 12 (or a portion thereof). In other words, the X-ray image is comprised of one or more pixels which correspond with the photodiode array of the X-ray detector.

The method 150 continues at 165 as the X-ray image generated at 160 is binned per the region of interest selected by a user, such as a clinician or radiologist. In some embodiments, the binning process is performed within (or at) the X-ray detector 40 prior to transmitting the binned image to the display device 12, thereby maximizing the region of interest at the highest resolution the display device is capable of displaying while reducing the total number of pixels which must ultimately be transmitted to the system and/or display device.

Binning can include a process of combining two or more detector physical pixels to form a single larger, or super, virtual image pixel. According to some embodiments, binning is performed to reduce the total number of pixels which must ultimately be transmitted and digitally processed; nevertheless, a suitable number of pixels are transmitted in order to maintain or preserve image quality or resolution. In some embodiments, the binning process is optimized to achieve a high quality image without overwhelming the system.

In general, starting with comparatively large individual pixels and/or binning an unnecessarily large number of pixels can result in a reduction of image spatial resolution. Thus, in accordance with various embodiments disclosed herein, a CMOS based X-ray detector facilitates the use of comparatively small pixels. In this way, various binning processes can be performed without unduly sacrificing image quality and resolution.

As mentioned above, in some further embodiments, the binning process can be optimized. According to such embodiments, the binning process is variable or dynamic such that a clinician can select a desirable region of interest and the binning process is performed to optimize the number of pixels binned. In this way, the number of pixels that are binned is selected so as to fit within the transmission capability and speed of X-ray system 15 as well as the resolution capacity of an associated display device while maximizing the total number of pixels transmitted in order to transmit the highest quality, or highest spatial resolution, image capable of being displayed on the display device. In some embodiments, the clinician can reselect or change the desired region of interest, or select a sub-region of interest, and the dynamic binning process is cyclically performed anew each time the clinician changes the desirable region of interest so as to, once again, optimize the number of pixels transmitted according to system capacity and desirable image resolution.

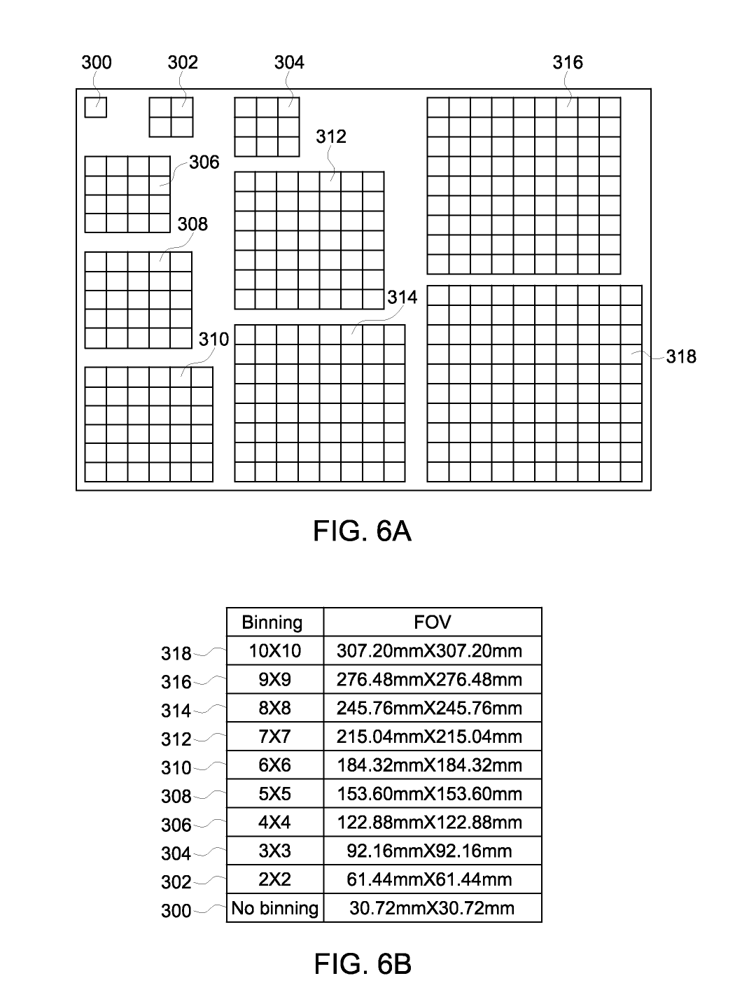

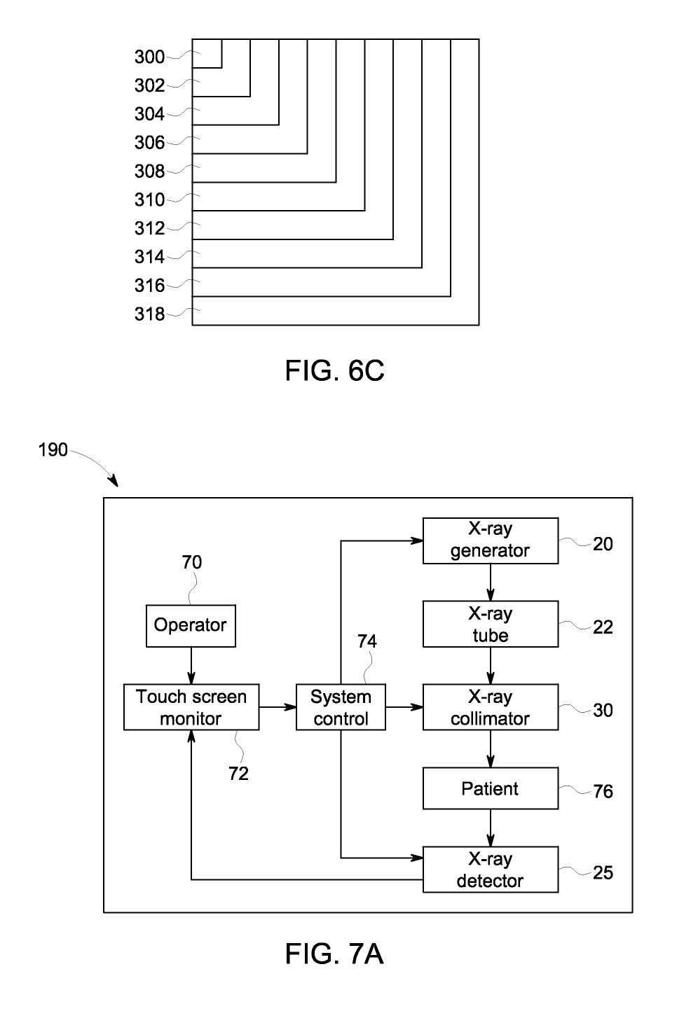

FIGS. 6A through 6C show some embodiments of the binning process. In these embodiments, for example, a digital flat panel CMOS based X-ray detector 40 has an active area of 307.2 mm×307.2 mm and the detector's physical, photodiode pixel array is comprised of pixels having a height and width of 24 μm×24 μm. In this example, the X-ray detector will have a total of 12800×12800 pixels (370,200 μm/24 μm per pixel=12,800 pixels). The range of pixel sizes or dimensions can be employed consistent with the methods and structures disclosed herein, including pixels having any suitable size or dimension within the range of approximately 10 μm×10 μm up to approximately 50 μm×50 μm for a square pixel.

In some embodiments, no binning is performed and the resulting X-ray image is transmitted at a resolution of 12800×12800. In other embodiments, however, the speed and processing capability of the system, as well as the available display resolution, will dictate the necessity of binning the X-ray image prior to transmission of the same so as to facilitate the real, or near real, time and/or functional operation of the system within system parameters or capacity. To this end, the initial 12800×12800 pixels will be binned and only the amount of pixels necessary to fill the display area of the display device will transmitted. By way of example, in some embodiments, the display device dimension is 1280×1280, which, as understood by those of skill in the art, is capable of being realized over a wired-gigabit Ethernet connection at a frame rate of 30 frames per second, for example.

The proper amount of pixels can be binned within or at the X-ray detector to achieve a desirable, or the user selected, field of view prior to transferring the binned image via the X-ray system to the display device 12. For example, if the user desires a field of view of approximately 31 cm×31 cm, then every 10×10 pixels are binned into a single larger, or super, virtual pixel 318 (not to scale) and transferred to the system such that the resulting image is 1280×1280 (12800 pixels/100 pixels per super pixel) consistent with the capabilities of an X-ray system utilizing a wired-gigabit Ethernet connection at a frame rate of 30 frames per second as well as the associated display device having an image display of 1280×1280. In this way, the selected field of view fills the entire display area of the display device with the selected region of interest at the system capacity, or best available, spatial resolution.

In other configurations, if the user desires a field of view of approximately 21.5 cm×21.5 cm, then every 7×7 pixels can be binned into a single larger, or super, virtual pixel 312 (not to scale) and transferred to the system such that the resulting image is 1280×1280 consistent with the system and/or display device capabilities or limits. In this way, the selected field of view fills the entire display area of the display device with the selected region of interest at the system capacity, or best available, spatial resolution. Due to the adjusted dynamic binning process, however, not only is a smaller region of interest enlarged, the spatial resolution of the resulting transmitted image is changed commensurate with the enlargement in order to preserve or improve image quality over a magnified but physically smaller region of interest.

As illustrated in FIGS. 6A through 6C, numerous and variable binning processes are contemplated in order to achieve the benefits of the methods and structures disclosed herein with a range of user selected fields of view. For example, FIG. 6A shows different binning options to achieve different fields of view 300 through 318 (not to scale) in connection with a display device having a fixed image display dimension of 1280×1280 pixels according to some embodiments. FIG. 6B further illustrates a table of binning choices and their corresponding fields of view giving a final image display of 1280×1280 pixels while FIG. 6C illustrates the corresponding different fields of view for the given example relative to one another.

Using the binning processes allows an operator to select a larger field of view and to simultaneously magnify the associated region of interest while commensurately changing or increasing the spatial resolution thereof akin to an optical type zoom, as opposed to merely achieving a type of digital zoom wherein a fixed or static number of individual pixels are simply enlarged and approximated via two-dimensional interpolation resulting in distortions, or pixilation, the closer a user attempts to view the region of interest. In some embodiments, the binning processes associated with the structures and methods disclosed herein can be achieved by providing sufficiently small pixels such that enough pixels exist to enlarge an image while changing the spatial resolution of the image commensurate with the enlargement rather than via interpolation, in which image resolution is diminished as individual pixels are blown up and approximated.

Numerous additional embodiments are contemplated in connection with X-ray detectors having a larger or smaller receptor area and/or larger or smaller pixels. In some embodiments, numerous additional fields of view may be achieved, even for the same fixed display of 1280×1280, for example, by utilizing a pixel size that is less than 24 μm and even as small as 10 μm. In other embodiments, display devices capable of exceeding a resolution of 1280×1280 are also contemplated. Likewise, rectangular display devices are contemplated. Regardless, according to various embodiments, the binning processes described and disclosed herein result in a binned image that fits or fills the dimensions of a display device with the region of interest of a patient's anatomy.

The method 150 continues at 170 as the binned X-ray image is optionally transmitted to the X-ray system and/or display device (e.g., a square or rectangular monitor, screen, projector, TV, tablet/handheld device, etc.). Following transmission, the binned X-ray image is optionally viewable on the display device 12, as shown at 175. In some embodiments, transmission 170 occurs in real, or near real, time. The binned X-ray image can take up any suitable amount of the display device's display area, including the entire display area, so as to maximize both the size and resolution of the region of interest to be viewed. A clinician or radiologist may then optionally view the binned image in order to evaluate the contents thereof, such as for purposes of diagnosing medical conditions, prescribing suitable medical treatments, and so forth.

The method 150 continues at 180 when a clinician or radiologist can optionally and selectively zoom in on a chosen region of interest, or sub-region of interest, such that the zoomed region of interest or corresponding X-ray image is enlarged or magnified so as to fill the entire display area with a closer or magnified view of the newly selected region of interest while generally maintaining image resolution. Upon zooming in, the processes at 165, 170 and 175 are capable of cyclical repetition such that the clinician can reselect or change the desired region of interest, or sub-region of interest, and the dynamic binning process described above is performed anew each time the clinician changes the desirable region of interest thereby re-optimizing and re-binning the number of pixels transmitted according to system capacity and desirable image resolution. The processes at 165, 170, 175 and 180 are capable of being repeated as many times as a user desires in order to cyclically bin and re-bin select regions of interest, or sub-regions of interest, of a patient's anatomy.

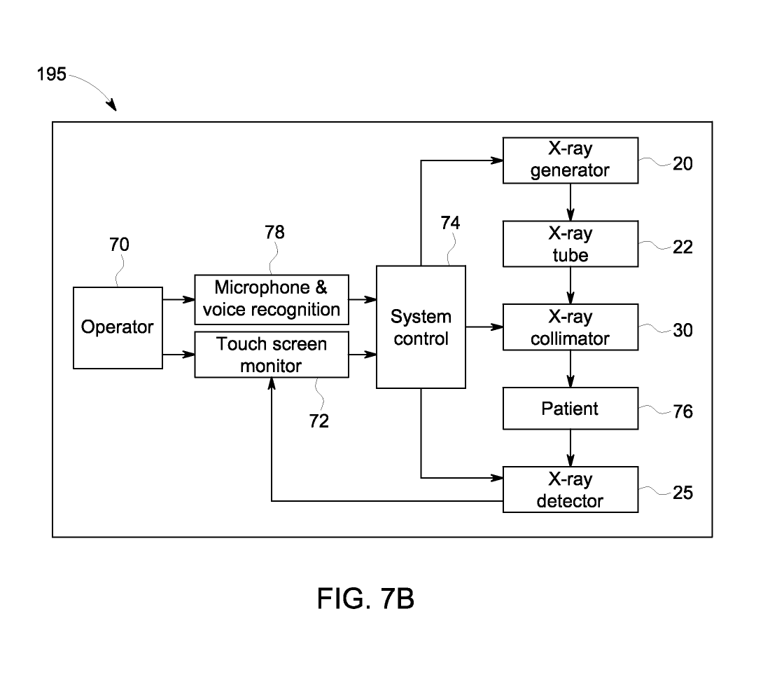

FIGS. 7A and 7B illustrate other embodiments of the X-ray systems that can be used to produce the X-ray image 10. In FIG. 7A, the X-ray system 190 is controlled by an operator 70, such as a clinician, a doctor, a radiologist, a technician, or other medically trained professionals and/or staff. In some embodiments, the system operator 70 controls the X-ray system 190 at or from a central system control, such as a system control console, at 74 (see also FIGS. 2A and/or 2B). According to various embodiments, operator 70 interfaces with the system control 74 through a variety of optional user interfaces. Either the system control console 74, the user interface, or both is/are located adjacent the X-ray system according to some embodiments. In on other embodiments, however, either the system control console 74, the user interface, or both is/are located remotely, such as in an adjacent room, so as to protect operator 70 from unnecessary exposure to X-rays.

With respect to the various optional user interfaces, in some embodiments, operator 70 controls the X-ray system 190 through a touch-screen monitor 72 (see also FIGS. 2A and/or 2B). According to some implementations, the system will default to displaying the X-rayed object, such as a portion of a patient's 76 body or any object through which an X-ray beam is passed, utilizing the full field of view available based on the dimensions and active area of either the X-ray source or generator 20 and/or the X-ray detector 25. As desired and/or necessary, operator 70 can then optionally select and zoom in on or enlarge a particular region of interest of the patient's 76 anatomy in order to obtain a closer and/or more detailed view of the selected region. In some embodiments, operator 70 can zoom in as described by using the touch-screen user interface 72.

For example, operator 70 can draw a shape, such as a circle, a triangle, a square, a rectangle, an ellipse, a super-ellipse, an oval, or any other suitable shape, including irregular and/or non-polygonal shapes, on the touch-screen monitor 72 to select a particular region of interest or sub-region of interest of the image then being displayed on the monitor. In other embodiments, operator 70 can tap the touch-screen monitor at a region of interest or sub-region of interest of the image then being displayed on the monitor in a predetermined pattern, such as a “double tap,” a “triple tap,” or any other predetermine number of taps. In yet other embodiments, operator 70 can select a region of interest using two or more touching implements, such as the user's fingers, and swiping, pinching, dragging or otherwise moving the touching implements in a predetermined pattern. For example, in some embodiments, operator 70 can place the pads of his or her index finger and thumb at opposite corners of the region of interest and then drag both fingers toward the center of the region of interest until a suitable field of view is displayed. In still other embodiments, the touch-screen user interface or monitor will include touch-control spots or virtual buttons, the use of which enable operator 70 to select a chosen region of interest. In all such embodiments, the user can use any suitable touching implement, such as the user's fingers or a stylus, to control X-ray system 15 via user interface, such as touch screen monitor 72.

In other embodiments, operator 70 controls the X-ray system 195 through a voice activated and/or voice operated user interface, including microphone and voice recognition 78, as shown in FIG. 7B. In some implementations, the system will default to displaying the full field of view available based on the system components. As desired and/or necessary, operator 70 can then optionally select and zoom in on or enlarge a particular region of interest via various voice control components, such as a microphone and compatible voice recognition software. In some embodiments, operator 70 can zoom in as described by using voice activated and/or voice operated user interface. In some embodiments, this user interface may be preprogrammed to recognize certain voice commands, such as “go default,” “shift n inches left,” “shift n inches right,” “shift n inches up,” “shift n inches down,” “zoom in,” “zoom out,” “zoom in n percent,” “zoom out n percent,” “full field of view,” “reduce noise,” “reduce dose,” and so forth, where “n” is a dimension or numerical figure supplied by the user as necessary. According to various embodiments, any suitable voice commands may be pre-programmed. In other embodiments, additional or varied voice commands are created and established by the user as necessary. In still other embodiments, operator 70 controls the zooming or locational functions of the X-ray system through, or in connection with, other hardware and/or software components, such as a keyboard, a mouse, a track pad, a joystick, and/or other components, including mechanical and/or manual adjustment components.

The system can zoom in on or adjusts the region of interest identified by the operator 70 by any one or more of the touch-screen, voice control, or hardware control methods or systems previously described. In some embodiments, upon receiving the user-selected region of interest, the X-ray beam is then moved to the selected region of interest via various X-ray system components, such as a four-leafed collimator, a two-leafed collimator, or other system components. According to some embodiments, a collimator enables a user, operator, clinician, radiologist, or the like to center an aperture defined by the collimator over any discrete point of the active or receptive area of the X-ray detector.

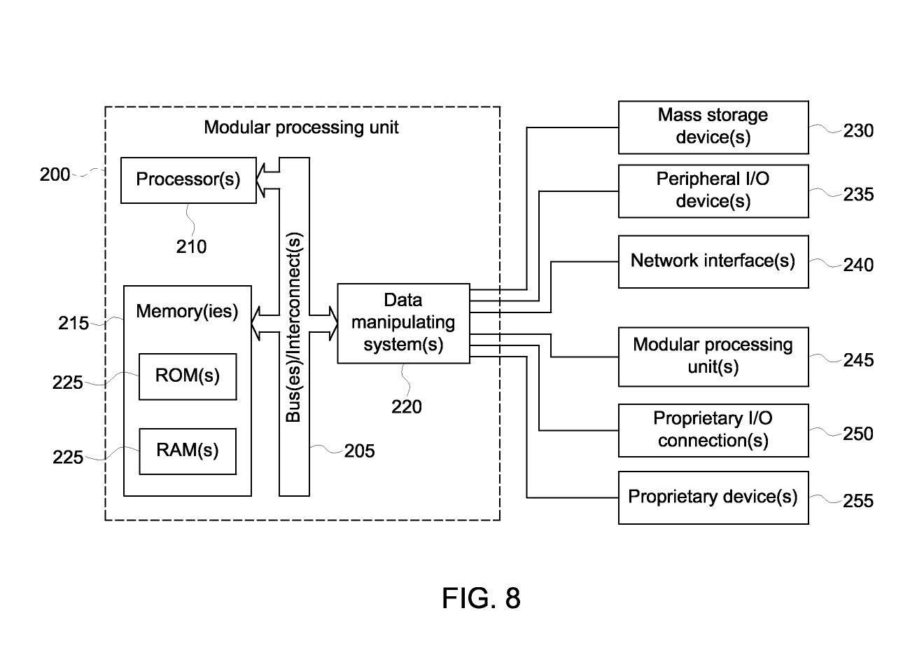

The X-ray system 190 can be used to display the described X-ray images and manipulating or adjusting such images, such as by zooming in on a particular region of interest, or sub-region of interest, within the existing image, via a touch screen monitor 72. The operator 70 accesses or interfaces with the X-ray system via a central system control 74 via touch-screen user interface 72. By means of the touch-screen user interface 72 and system control 74, operator 70 controls X-ray generator 20 to generate an X-ray beam which is then passed through X-ray tube 22, X-ray collimator 30, and patient 76 so as to be received at X-ray detector 25. As previously described, the resulting X-ray image is binned as necessary at X-ray detector 25 after which it is transmitted to touch-screen monitor 72 for the operator's examination. These actions may be repeated as necessary and an indefinite number of times in order for operator 70 to obtain a suitable field of view of a user-selected region of interest. The X-ray system 195 in FIG. 7B operates similarly by utilizing either a touch-screen monitor 72, a voice operated sub-system 78, or both.

Where the binned X-ray images 10 are shown and/or manipulated on a display device 12, the display device 12 can be used with any suitable computing environment. FIG. 8 describes some embodiments of one exemplary computing environment. These embodiments can include one or more processing units in a variety of customizable enterprise configurations, including in a networked or combination configuration. These embodiments can include one or more computer readable media, wherein each medium may be configured to include or includes thereon data or computer executable instructions for manipulating data. The computer executable instructions can include data structures, objects, programs, routines, or other program modules that may be accessed by one or more processors, such as one associated with a general-purpose modular processing unit capable of performing various different functions or one associated with a special-purpose modular processing unit capable of performing a limited number of functions.

Computer executable instructions cause the one or more processors of the enterprise to perform a particular function or group of functions and are examples of program code means for implementing steps for methods of processing. Furthermore, a particular sequence of the executable instructions provides an example of corresponding acts that may be used to implement such steps.

Examples of computer readable media (including non-transitory computer readable media) include random-access memory (“RAM”), read-only memory (“ROM”), programmable read-only memory (“PROM”), erasable programmable read-only memory (“EPROM”), electrically erasable programmable read-only memory (“EEPROM”), compact disk read-only memory (“CD-ROM”), any solid state storage device (e.g., flash memory, smart media, etc.), or any other device or component capable of providing data or executable instructions that may be accessed by a processing unit.

With reference to FIG. 8, a representative enterprise includes modular processing unit 200, which may be used as a general-purpose or special-purpose processing unit. For example, modular processing unit 200 may be employed alone or with one or more similar modular processing units as a personal computer, a notebook computer, a personal digital assistant (“PDA”) or other hand-held device, a workstation, a minicomputer, a mainframe, a supercomputer, a multi-processor system, a network computer, a processor-based consumer device, a cellular phone, a smart appliance or device, a control system, or the like. Using multiple processing units in the same enterprise provides increased processing capabilities. For example, each processing unit of an enterprise can be dedicated to a particular task or can jointly participate in distributed processing.

In FIG. 8, the modular processing unit 200 includes one or more buses and/or interconnects 205, which may be configured to connect various components thereof and enables data to be exchanged between two or more components. The bus(es)/interconnect(s) 205 may include one of a variety of bus structures, including a memory bus, a peripheral bus, or a local bus that uses any of a variety of bus architectures. Typical components connected by the bus(es)/interconnect(s) 205 include one or more processors 210 and one or more memories 215. Other components may be selectively connected to the bus(es)/interconnect(s) 205 through the use of logic, one or more systems, one or more subsystems and/or one or more I/O interfaces, hereafter referred to as data manipulating system(s) 220. Moreover, other components may be externally connected to the bus(es)/interconnect(s) 205 through the use of logic, one or more systems, one or more subsystems and/or one or more I/O interfaces, and/or may function as logic, one or more systems, one or more subsystems, and/or one or more I/O interfaces, such as one or more modular processing unit(s) 245 and/or proprietary device(s) 255. Examples of I/O interfaces include one or more mass storage device interfaces, one or more input interfaces, one or more output interfaces, and the like. Accordingly, embodiments of the described systems and methods embrace the ability to use one or more I/O interfaces and/or the ability to change the usability of a product based on the logic or other data manipulating system employed.

The logic may be tied to an interface, part of a system, subsystem and/or be used to perform a specific task. Accordingly, the logic or other data manipulating system may allow, for example, for IEEE1394 (firewire), wherein the logic or other data manipulating system is an I/O interface. Alternatively or additionally, logic or another data manipulating system may be used that allows a modular processing unit to be tied into another external system or subsystem. For example, an external system or subsystem that may or may not include a special I/O connection. Alternatively or additionally, logic or another data manipulating system may be used wherein no external I/O is associated with the logic. Embodiments of the described systems and methods also embrace the use of specialty logic, such as for ECUs for vehicles, hydraulic control systems, etc. and/or logic that informs a processor how to control a specific piece of hardware. Moreover, those skilled in the art will appreciate that embodiments of the described systems and methods embrace a plethora of different systems and/or configurations that utilize logic, systems, subsystems and/or I/O interfaces.

As provided above, embodiments of the described systems and methods embrace the ability to use one or more I/O interfaces and/or the ability to change the usability of a product based on the logic or other data manipulating system employed. For example, where a modular processing unit is part of a personal computing system that includes one or more I/O interfaces and logic designed for use as a desktop computer, the logic or other data manipulating system can be changed to include flash memory or logic to perform audio encoding for a music station that wants to take analog audio via two standard RCAs and broadcast them to an IP address. Accordingly, the modular processing unit may be part of a system that is used as an appliance rather than a computer system due to a modification made to the data manipulating system(s) (e.g., logic, system, subsystem, I/O interface(s), etc.) on the back plane of the modular processing unit. Thus, a modification of the data manipulating system(s) on the back plane can change the application of the modular processing unit. Accordingly, embodiments of the described systems and methods embrace very adaptable modular processing units.

As provided above, processing unit 200 includes one or more processors 210, such as a central processor (or CPU) and optionally one or more other processors designed to perform a particular function or task. It is typically the processor 210 that executes the instructions provided on computer readable media, such as on the memory(ies) 215, a magnetic hard disk, a removable magnetic disk, a magnetic cassette, an optical disk, or from a communication connection, which may also be viewed as a computer readable medium.

The memory(ies) 215 includes one or more computer readable media that may be configured to include or includes thereon data or instructions for manipulating data, and may be accessed by the processor(s) 210 through the bus(es)/interconnect(s) 205. The memory(ies) 215 may include, for example, ROM(s) 225, used to permanently store information, and/or RAM(s) 225, used to temporarily store information. The ROM(s) 225 may include a basic input/output system (“BIOS”) having one or more routines that are used to establish communication, such as during start-up of the modular processing unit 200. During operation, the RAM(s) 225 may include one or more program modules, such as one or more operating systems, application programs, and/or program data.

As illustrated, at least some embodiments of the described systems and methods embrace a non-peripheral encasement, which provides a more robust processing unit that enables use of the unit in a variety of different applications. In FIG. 8, one or more mass storage device interfaces (illustrated as data manipulating system(s) 220) may be used to connect one or more mass storage devices 230 to the bus(es)/interconnect(s) 205. The mass storage devices 230 are peripheral to the modular processing unit 200 and allow the modular processing unit 200 to retain large amounts of data. Examples of mass storage devices include hard disk drives, magnetic disk drives, tape drives and optical disk drives.

A mass storage device 230 may read from and/or write to a magnetic hard disk, a removable magnetic disk, a magnetic cassette, an optical disk, or another computer readable medium. The mass storage devices 230 and their corresponding computer readable media provide nonvolatile storage of data and/or executable instructions that may include one or more program modules, such as an operating system, one or more application programs, other program modules, or program data. Such executable instructions are examples of program code means for implementing steps for methods disclosed herein.

The data manipulating system(s) 220 may be employed to enable data and/or instructions to be exchanged with the modular processing unit 200 through one or more corresponding peripheral I/O devices 235. Examples of the peripheral I/O devices 235 include input devices such as a keyboard and/or alternate input devices, such as a mouse, trackball, light pen, stylus, or other pointing device, a microphone, a joystick, a game pad, a satellite dish, a scanner, a camcorder, a digital camera, a sensor, and the like, and/or output devices such as a display device 115 (e.g., a monitor or display screen), a speaker, a printer, a control system, and the like. Similarly, examples of the data manipulating system(s) 220 coupled with specialized logic that may be used to connect the peripheral I/O devices 235 to the bus(es)/interconnect(s) 205 include a serial port, a parallel port, a game port, a universal serial bus (“USB”), a firewire (IEEE 1394), a wireless receiver, a video adapter, an audio adapter, a parallel port, a wireless transmitter, any parallel or serialized I/O peripherals or another interface.

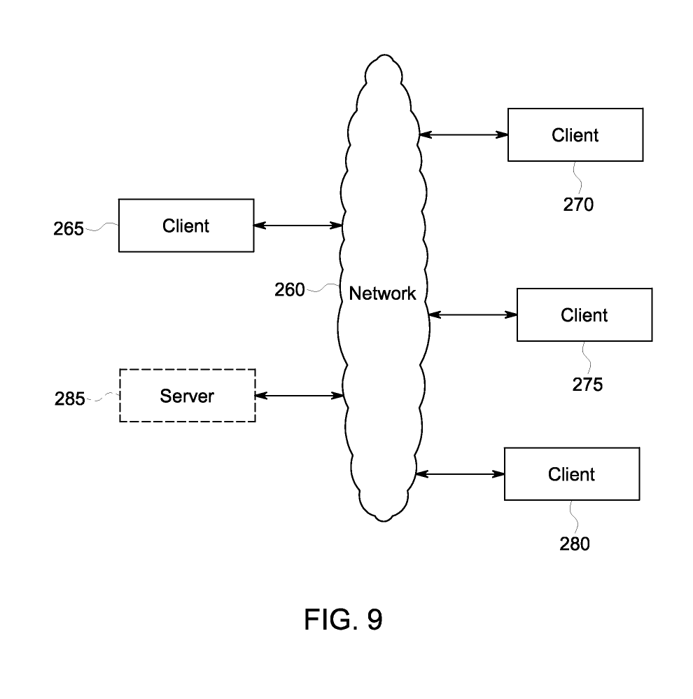

The data manipulating system(s) 220 enable an exchange of information across one or more network interfaces 240. Examples of the network interfaces 240 include a connection that enables information to be exchanged between processing units, a network adapter for connection to a local area network (“LAN”) or a modem, a wireless link, or another adapter for connection to a wide area network (“WAN”), such as the Internet. The network interface 240 may be incorporated with or peripheral to modular processing unit 200, and may be associated with a LAN, a wireless network, a WAN and/or any 260 connection (see FIG. 9) between processing units.

The data manipulating system(s) 220 enables the modular processing unit 200 to exchange information with one or more other local or remote modular processing units 245 or computer devices. A connection between modular processing unit 200 and modular processing unit 245 may include hardwired and/or wireless links. Accordingly, embodiments of the described systems and methods embrace direct bus-to-bus connections. This enables the creation of a large bus system. It also eliminates hacking as currently known due to direct bus-to-bus connections of an enterprise. Furthermore, the data manipulating system(s) 220 enable the modular processing unit 200 to exchange information with one or more proprietary I/O connections 250 and/or one or more proprietary devices 255.

Program modules or portions thereof that are accessible to the processing unit may be stored in a remote memory storage device. Furthermore, in a networked system or combined configuration, the modular processing unit 200 may participate in a distributed computing environment where functions or tasks are performed by a plurality of processing units. Alternatively, each processing unit of a combined configuration/enterprise may be dedicated to a particular task. Thus, for example, one processing unit of an enterprise may be dedicated to video data, thereby replacing a traditional video card, and provides increased processing capabilities for performing such tasks over traditional techniques.

While those skilled in the art will appreciate that the described systems and methods may be practiced in networked computing environments with many types of computer system configurations, FIG. 9 represents an embodiment of a portion of the described systems in a networked environment that includes clients (265, 270, 275, 280, etc.) connected to a server 285 via a network 260. While FIG. 9 illustrates an embodiment that includes four clients connected to the network, alternative embodiments include one client connected to a network or many clients connected to a network. Moreover, embodiments in accordance with the described systems and methods also include a multitude of clients throughout the world connected to a network, where the network is a wide area network, such as the Internet. Accordingly, in some embodiments, the described systems and methods can allow a collimated image 10 to be taken in a first location and a user (e.g., a radiologist, technician, physician, etc.) to view, rotate, and otherwise manipulate the image from a second location.

As previously mentioned, the described systems and methods can be modified in any suitable manner. In one example, where computer software is used to display the described binned X-ray images 10 on a display device, the software can be used to clean up the images in any suitable manner. For instance, the software can be used to remove shadows, fuzzy lines, or to otherwise sharpen the image's edges.

The described systems and methods for displaying binned X-ray images 10 have several useful features. Some conventional X-ray detectors have used amorphous silicon (a-Si) based detectors having a random crystal lattice. Such detectors have various challenges, one of which is that the random crystal structure impedes the efficient transmission of electronic signals thus impeding the overall timeliness of the X-ray system. The random crystal structure also limits the size of the pixels which may be employed in the detector thus impeding the functional image detail which may be captured and transmitted via the system. In addition, if these X-ray systems have any zooming capability at all, any such zooming function comprises a digital zoom by which images are enlarged but spatial resolution remains unchanged thus giving a user a closer view but without enhancing the image detail. Worse, digitally zooming in too close results in distortions, such as pixilation of the image as the pixels themselves are simply enlarged and approximated using linear interpolation. But using the CMOS or c-Si based detectors allows better imaging relative to a-Si based detectors.

As well, some conventional zooming methods use a digital zoom that distorts the image, relies on imprecise linear interpolation, results in pixilation, or simply does not alter the spatial resolution commensurate with zooming thus failing to increase the level of detail shown in the image. But the described systems and methods utilize various dynamic binning processes to modify spatial resolution as a region of interest is enlarged so as to simultaneously magnify the dimensions over which the region of interest is shown as well as the spatial resolution or detail visible in the displayed image. Thus, users of the described systems can see better detail on the binned images than may be obtained through some other conventional methods. In other words, an operator (e.g., a clinician or radiologist) can selectively zoom in on a chosen region of interest such that the zoomed region of interest or corresponding X-ray image is enlarged or magnified so as to fill the entire display area with a closer or magnified view of the selected region of interest while generally maintaining or improving image resolution. Thus, the described X-ray image can maintain or improve its resolution while maximizing the on-screen image size and efficiently utilizing the resolution capacity and display area of display device 12. This functionality is realized by designing the pixel size of the CMOS based X-ray detector suitably small such that the pixels can be appropriately binned in order to fit the resulting X-ray image to the dimensions of display device 12 with the region of interest of a patient's anatomy while maintaining or increasing the spatial resolution of image 10 according to methods and structures disclosed herein. In this way, the X-ray image fills the dimensions of display device 12 with the region of interest the clinician or radiologist wishes to view while simultaneously providing as much detail in image 10 as possible.

In addition to any previously indicated modification, numerous other variations and alternative arrangements may be devised by those skilled in the art without departing from the spirit and scope of this description, and the appended claims are intended to cover such modifications and arrangements. Thus, while the information has been described above with particularity and detail in connection with what is presently deemed to be the most practical and preferred aspects, it will be apparent to those of ordinary skill in the art that numerous modifications, including, but not limited to, form, function, manner of operation, and use may be made without departing from the principles and concepts set forth herein. Also, as used herein, the examples and embodiments, in all respects, are meant to be illustrative only and should not be construed to be limiting in any manner.

1. An X-ray system, comprising:
an X-ray source;
a CMOS based X-ray detector having an active area of an array of physical detector pixels for detecting X-rays from the X-ray source and capable of adjusting a virtual image pixel size by binning multiple physical detector pixels together according to a desired region of interest;
a collimator defining an aperture, wherein the collimator is configured to center the aperture over any portion of the active area of the CMOS based X-ray detector; and
a display device configured to receive and display an X-ray image comprised of an array of virtual image pixels that have been previously binned at the CMOS based X-ray detector.

2. The system of claim 1, wherein the X-ray image is generated by passing the X-ray beam through the aperture of the collimator and onto an object placed between the X-ray source and the CMOS based X-ray detector.

3. The system of claim 2, wherein the array of virtual image pixels corresponds with the array of physical detector pixels.

4. The system of claim 3, wherein the array of virtual image pixels are binned according to a region of interest selected by a user.

5. The system of claim 1, wherein the display device is configured to display the X-ray image so that it fills the display dimensions of the display device.

6. The system of claim 5, further comprising a touch-screen user interface enabling a user to select a sub-region of interest of the X-ray image and to zoom in on the sub-region of interest, and wherein one or more virtual image pixels are re-binned according to the sub-region of interest selected by the user.

7. The system of claim 1, wherein the collimator comprises multiple collimator plates that can be moved to define the size of the aperture.

8. The system of claim 7, wherein the aperture can be moved across the entire active area of the CMOS based X-ray detector.

9. The system of claim 1, wherein the array of physical detector pixels is comprised of pixels having a pixel size ranging from about 10 μm×10 μm to about 50 μm×50 μm.

10. A method for acquiring and displaying an X-ray image, comprising:
providing an X-ray system comprising:
an X-ray source;
a CMOS based X-ray detector having an active area for detecting a X-rays from the X-ray source and capable of adjusting a virtual image pixel size by binning multiple physical detector pixels together according to a desired region of interest; and
a collimator defining an aperture, wherein the collimator is configured to center the aperture over any portion of the active area of the CMOS based X-ray detector; and
generating an X-ray image of an object placed between the X-ray source and the CMOS based X-ray detector, wherein the X-ray image visualizes an array of virtual image pixels that have been previously binned at the CMOS based X-ray detector.

11. The method of claim 10, further comprising displaying the X-ray image on a display device.

12. The method of claim 10, wherein the array of virtual image pixels corresponds with an array of the physical detector pixels.

13. The method of claim 12, wherein the one array of virtual image pixels are binned according to a region of interest selected by a user.

14. The method of claim 10, wherein the display device is configured to display the X-ray image so that it fills the display dimensions of the display device.

15. The method of claim 14, further comprising a touch-screen user interface enabling the user to select a sub-region of interest of the X-ray image and to zoom in on the sub-region of interest, and wherein the one or more X-ray image pixels are re-binned according to the sub-region of interest selected by a user.

16. The method of claim 10, wherein the collimator comprises multiple collimator plates that can be moved to define the size of the aperture.

17. The method of claim 16, wherein the aperture can be moved across the entire active area of the CMOS based X-ray detector.

18. An X-ray system, comprising:
an X-ray source;
a CMOS based X-ray detector having an active area of an array of physical detector pixels for detecting X-rays from the X-ray source and capable of adjusting a virtual image pixel size by binning multiple physical detector pixels together according to a desired region of interest; and
a collimator defining an aperture, wherein the collimator is configured to center the aperture over any portion of the active area of the CMOS based X-ray detector.

19. The system of claim 18, further comprising a display device configured to receive and display an X-ray image comprised of an array of virtual image pixels that have been previously binned at the CMOS based X-ray detector.

20. The system of claim 18, wherein the array of virtual image pixels are binned according to a region of interest selected by a user.
